(19) United States
(12) Patent Application Publication
(10) Pub. No.: US 2013/0311343 A1
(43) Pub. Date: Nov. 21, 2013

(54) Determining the Probability of Default for a Depository Institution

(71) Applicant: Rebel Cole, (US)

(72) Inventor: Rebel COLE, Chicago, IL (US)

(21) Appl. No.: 13/836,618

(22) Filed: Mar. 15, 2013

Related U.S. Application Data
(60) Provisional application No. 61/648,680, filed on May 18, 2012.

(51) Int. Cl. G06Q 40/02

(52) U.S. Cl. CPC G06Q 40/02
USPC 705/35

(57) ABSTRACT

Systems and methods are provided for determining an indication that a depository institution (such as a bank) will default on its credit obligations to counterparties. In one embodiment, a method includes receiving information about the bank's financial performance and condition, bank structure information, bank closure information and other information about national and regional economic conditions; using this information to build a banking database; and then generating the indication representing the probability of default for each bank in the database. The analytical tool compares the historical characteristics of defaulting banks with those of non-defaulting banks during a training period, and generates an indication that can be interpreted as the probability of default for each individual bank during that period of time. An early-warning component of the system then generates an indication that can be interpreted as the expected probability of default for each surviving bank during a forward-looking forecast period.

### CROSS-REFERENCE TO RELATED APPLICATION

The instant application claims the benefit of Provisional U.S. Patent Application Ser. No. 61/648,680 entitled “SYSTEMS AND METHOD FOR DETERMINING THE PROBABILITY OF DEFAULT FOR A DEPOSITORY INSTITUTION” and filed May 18, 2012, the teachings of which are incorporated herein by this reference.

### FIELD

The instant disclosure generally relates to financial systems, and to systems and methods for processing financial information. More particularly, the instant disclosure relates to systems and methods for determining the likelihood that a depository institution will default on credit obligations to its counterparties, including uninsured depositors and other creditors. As used herein, a ‘depository institution’ is any organization or entity that issues checking or savings accounts to the public and includes, but is not limited to, commercial banks, credit unions, savings associations, and thrift institutions. For ease of explanation, the term ‘bank’ is used to throughout the instant description as shorthand for ‘depository institution.’

### BACKGROUND

When one party such as a financial institution or private investor lends money or otherwise invests in a bank, or otherwise is exposed to potential losses should the bank default or be seized by regulators, the party is said to be exposed to counterparty risk. Consequently, financial institutions and other creditors such as private investors are interested in monitoring their counterparty risk as a part of sound risk-management practices. Regulated banks are required to conduct such risk-management procedures.

In addition, investors in the equity shares of a bank are interested in monitoring the bank's default risk as a tool to guide their portfolio allocation to that bank. Such investors could hold a “long” position in the bank's equity shares, meaning that the value of their investment rises when the value of the bank's equity shares rise; or such investors could hold a “short” position in the bank's equity shares, meaning that the value of their investment rises when the value of the bank's equity shares fall in value. Such investors can use the probability of default, or period-to-period changes in the probability of default, as a guide for identifying investment opportunities. When the probability of default is rising, investors might want to take a short position in the bank's shares; when the likelihood of default is falling, investors might want to take a long position in the bank's shares.

It would therefore be advantageous to provide techniques for determining the probability of default of banks.

### SUMMARY

Accordingly, the instant disclosure is directed to systems and methods for processing financial information and, more particularly, systems and methods for determining the probability that a financial institution will be closed by its primary regulator, or in any other way default on its credit obligations to depositors and other creditors.

A financial system consistent with the systems and methods of the instant disclosure may receive information on the performance and condition of the bank, including, but not limited to, information on capital adequacy, asset quality, management quality, earnings and liquidity, as well as information on whether the bank has been closed by its primary regulator. The system may populate a database with received information, transform this information into financial ratios and other variables that are useful for modeling default risk. Based on the transformed information, an indication is determined that represents a measure of the probability that the bank was closed during a training period, leading it to default on its credit obligations. An early warning component of the system then generates a forward-looking indication that represents the probability that the bank will default during a forward-looking forecast period.

### BRIEF DESCRIPTION OF THE DRAWINGS

The features described in this disclosure are set forth with particularity in the appended claims. These features will become apparent from consideration of the following detailed description, taken in conjunction with the accompanying drawings. One or more embodiments are now described, by way of example only, with reference to the accompanying drawings wherein like reference numerals represent like elements and in which:

FIG. 1 schematically illustrates an exemplary system environment for determining an indication of whether a bank is likely to default in accordance with an embodiment of the instant disclosure;

FIG. 2 is a functional block diagram associated with providing an indication of whether a bank is likely to default in accordance with an embodiment of the instant disclosure;

FIG. 3 is another schematic illustration of an exemplary system environment for determining an indication of whether a bank is likely to default in accordance with an embodiment of the instant disclosure;

FIG. 4 is a flowchart depicting processing for providing an indication that a bank is likely to default in accordance with an embodiment of the instant disclosure;

FIG. 5 illustrates an exemplary database for storing information needed to estimate the probability that a bank will default in accordance with an embodiment of the instant disclosure;

FIG. 6 illustrates exemplary bank structure information that may be received in accordance with an embodiment of the instant disclosure;

FIG. 7 shows an exemplary calculation of a probability-of-default (“PD”) Score indicating the likelihood that a bank will default in accordance with an embodiment of the instant disclosure;

FIG. 8 depicts an exemplary web page interface for providing a bank's PD Score to a bank counterparty in accordance with an embodiment of the instant disclosure;

FIG. 9 is an exemplary timeline showing steps for staging information from the banking database in accordance with an embodiment of the instant disclosure;

FIG. 10 is a flowchart depicting processing for generating a PD Score in accordance with an embodiment of the instant disclosure;

FIG. 11 is a flowchart depicting processing for determining coefficients for the PD Score model in accordance with an embodiment of the instant disclosure; and

FIG. 12 shows an exemplary table of information for determining PD model coefficients in accordance with an embodiment of the instant disclosure.

### DETAILED DESCRIPTION OF THE PRESENT EMBODIMENTS

Systems and methods consistent with the instant disclosure permit an entity, using a computing platform (or computer), to determine an indication of whether a bank is likely to default. In one embodiment, the indication is determined in the form of a score (also referred to herein as a Probability of Default or “PD”). When a score is used, a relatively low score may indicate that the bank is less likely to default, while a relatively high score may indicate that the bank is more likely to default, although it is understood that any suitable ranking or ordering scheme may be employed to differentiate various banks. The determined indication (or score) may then be provided to any entity, such as a financial institution, uninsured depositor, or other counterparty, so that the entity may take actions to limit its exposures to losses should the bank default. For example, the entity may prefer to enter into transactions with banks with lower PDs, to purchase credit insurance against the bank's default from a third party, or, in the case of a depositor, to reduce deposit accounts below the Federal Deposit Insurance Corporation's (FDIC) deposit-insurance limits. If the entity is an equity investor, it may wish to take a short position in the equity shares of a bank whose PD is rising from previous periods; or take a long position in the equity shares of a bank whose PD is falling from previous periods.

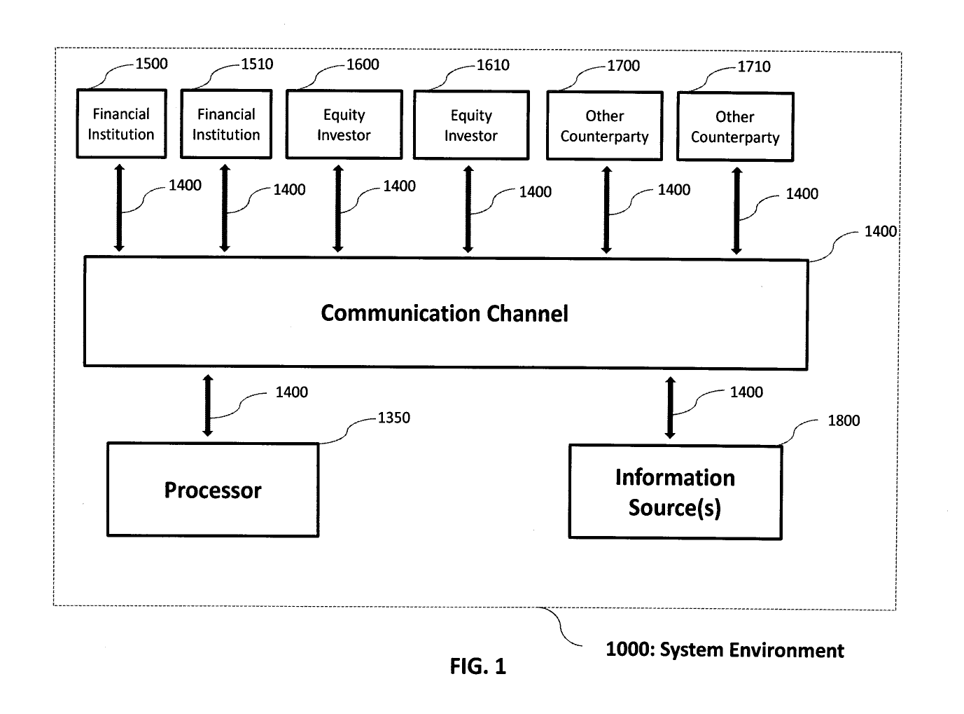

FIG. 1 shows an exemplary system 1000 for determining an indication of whether a bank is likely to default within a specified forward-looking time period. Referring to FIG. 1, the system includes a communication channel 1400, one or more financial institutions 1500, 1510, one or more equity investors 1600, 1610, or one or more other counterparties such as uninsured depositors 1700, 1710, information source(s) 1800, and a processor 1350.

Financial Institutions 1500 and 1510 may include a financial entity, such as a commercial bank, credit union, mortgage bank, savings bank, savings association and/or any other entity seeking an indication of whether a bank is likely to default. It is noted that, while FIG. 1 and the instant description make reference to specific examples of financial institutions and potential counterparties, those having ordinary skill in the art will appreciate that the instant disclosure is not limited in this regard.

Equity Investors 1600 and 1610 may include an entity, such as an individual investor, an investment advisor, a hedge fund or some other type of equity investor that wishes to take a long position or a short position in the bank's equity shares.

Other Counterparties 1700 and 1710 may include government-sponsored enterprises (GSEs) such as the Federal National Mortgage Association (commonly referred to as “Fannie Mae”) or the Federal Home Loan Mortgage Corporation (commonly referred to as “Freddie Mac”), or any other contractual counterparty to a bank that wishes to avoid losses in the event of a default by the bank. Other Counterparties 1700 and 1710 also may include an entity that has deposits in a bank in excess of the FDIC's limits on insured deposits. For example, the uninsured depositor could be an individual with an account in excess of the $250,000 limit on deposit insurance, a business with a commercial account not covered by deposit insurance, or any other uninsured depositor interested in protecting his or her deposits from loss in the event of a bank default. For ease of reference, all of the institutions 1500, 1510, investors 1600, 1610 and other counterparties 1700, 1710 illustrated in FIG. 1, along with any other entities that may be interested in receiving indications of probabilities of default of depository institutions may be collectively referred to herein as depository institution counterparties.

Information source(s) 1800 may include internal, external, proprietary, and/or public databases, such as financial databases and demographic databases. The information source(s) 1800 may include (or have access to) bank balance-sheet data, bank income-statement data, bank structure data; and national and regional economic indicators such as the unemployment rate, the number of bankruptcies, income per capita, housing values, loan default rates, and mortgage foreclosure rates. Some examples of such sources of information include SNL Securities, the Federal Financial Institutions Examination Council (FFIEC), the FDIC, the Bureau of Economic Analysis, the Bureau of Labor Statistics, Bloomberg, Case-Shiller, CoreLogic, Department of Commerce, Lender Processing Services, Standard & Poor and/or other sources known to those having skill in the art.

Processor 1350 may include any processing device capable of automating determination of an indication of whether a bank is likely to default. Processor 1350 may also be capable of providing that indication to, for example, Financial Institution 1500, Equity Investor 1600, Other Counterparty 1700, and/or any other entity requesting the indication.

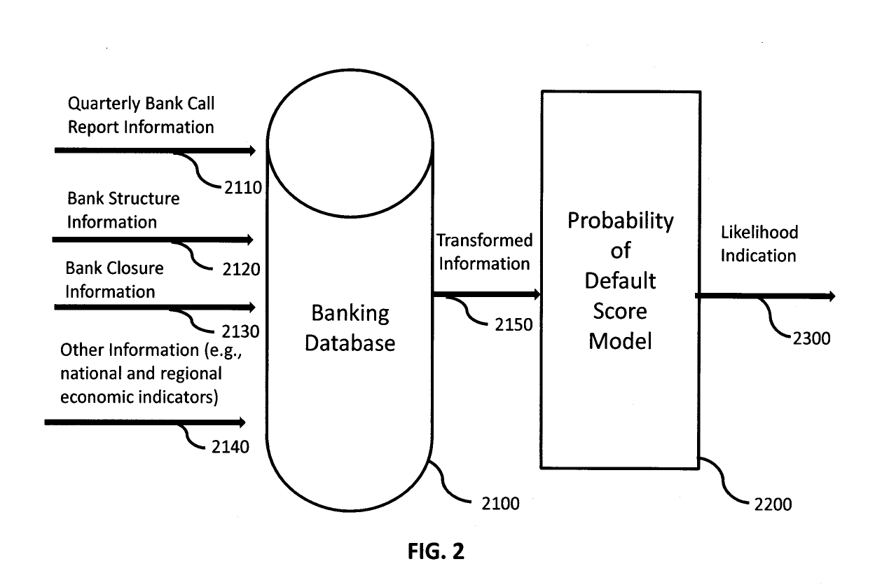

FIG. 2 depicts a functional block diagram associated with providing an indication of whether a bank is likely to default. Referring to FIGS. 1 and 2, Processor 1350 may receive via Communications Channel 1400 from Information Source(s) 1800, which may include the FDIC, the FFIEC, SNL Securities and other sources noted above, Quarterly Bank Call Report Information 2110, Bank Structure Information 2120, and Bank Closure Information 2130. Quarterly Bank Call Report Information 2110 may include financial-statement information, such as the balance-sheet and income statement data that can be used to construct proxies for the CAMELS ratings used by bank regulators to assess the financial condition of banks. These proxies include measures of capital adequacy, asset quality, management, earnings, liquidity and systemic risk. Bank Structure Information 2120 includes information on the geographic location of a bank, ownership structure of the bank, etc. Bank Closure Information 2130 includes information on the identity and geographic location of banks closed by bank regulators, as well as the date of closure and other information. One skilled in the art would recognize that Quarterly Bank Call Report Information 2110 could be information based upon monthly, semi-annual or annual reporting frequency.

Processor 1350 also may receive Other Information 2140 from Information Source(s) 1800, which include, but are not necessarily limited to, the Bureau of Labor Statistics, the Bureau of Economic Analysis, Bloomberg, Case-Shiller, Core Logic, Lender Processing Services, etc. Other Information 2140 may include measures of national and regional economic conditions, such as state and national unemployment rates, GDP growth, loan default rates, mortgage foreclosure rates, housing prices, income per capita and other measures of national and regional economic conditions.

Processor 1350 merges received information (2110-2140) and uses this information to populate Bank Database 2100. Processor 1350 transforms received information (2110-2140) into new variables such as financial ratios EQTA, NPATA, ROA, BDTA, SECTA and CDTA as described below; and then populates Bank Database 2100 with these new variables.

Based on Transformed Information 2150 from Bank Database 2100, and as described in greater detail below, Processor 1350 may then determine the indication (labeled as Likelihood Indication 2300) of whether a bank is likely to default. Processor 1350 may determine Likelihood Indication 2300 based on a model (labeled as Probability of Default Score Model 2200). Probability of Default Score Model 2200 is adapted to process Transformed Information 2150 from Bank Database 2100 and determine the Likelihood Indication 2300. Processor 1350 may also provide, through Communication Channel 1400, Likelihood Indication 2300 to any entity, such as Financial Institutions 1500, 1510, Equity Investors 1600, 1610, and/or Other Counterparties 1700, 1710.

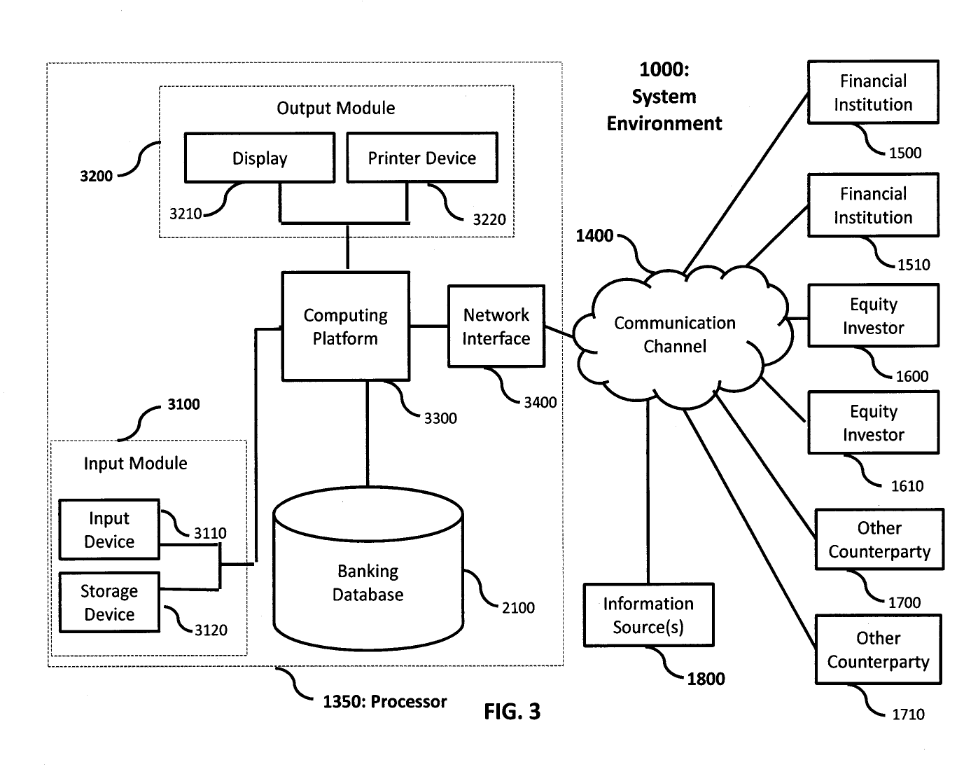

FIG. 3 depicts the exemplary system 1000 of FIG. 1 in greater detail with respect to Processor 1350. As illustrated in FIG. 3, the System Environment 1000 includes Communication Channel 1400, one or more Financial Institutions 1500, 1510, one or more Equity Investors 1600, 1610, one or more Other Counterparties 1700, 1710, Information Source(s) 1800, and Processor 1350. Processor 1350 may further include an Input Module 3100, an Output Module 3200, a Computing Platform 3300, the Database(s) 2100, and Network Interface 3400.

In one embodiment consistent with FIG. 3, the Computing Platform 3300 may include one or more data processors such as a PC, UNIX server, or mainframe computer for performing various functions and operations. Computing Platform 3300 may be implemented, for example, by a general purpose computer or data processor selectively activated or reconfigured by a stored computer program, or may be a specially constructed computing platform for carrying out the features and operations disclosed herein. Moreover, Computing Platform 3300 may be implemented or provided with a wide variety of components or systems as known in the art including, for example, one or more of the following: central processing unit, co-processor, memory, registers, and other data processing devices and subsystems.

Communication Channel 1400 may include, alone or in any suitable combination, a telephony-based network, a local area network (LAN), a wide area network (WAN), a dedicated intranet, the Internet or World Wide Web, a wireless network, a bus, or a backplane. Further, any suitable combination of wired and/or wireless components and systems may be incorporated into Communication Channel 1400. Moreover, Communication Channel 1400 may be embodied as bi-directional links or as unidirectional links.

Although Computing Platform 3300 may connect to Financial Institutions 1500, 1510, Equity Investors 1600, 1610, and/or Other Counterparties 1700, 1710 through Network Interface 3400 and Communication Channel 1400, Computing Platform 3300 may also connect directly to Financial Institutions 1500, 1510, Equity Investors 1600, 1610, and/or Other Counterparties 1700, 1710.

Computing Platform 3300 also communicates with Input Module 3100 and Output Module 3200 using connections or communication links, as illustrated in FIG. 3. Alternatively, communication between Computing Platform 3300 and Input Module 3100 or Output Module 3200 may be achieved using a network (not shown) similar to that described above for Communication Channel 1400. Further still, Input Module 3100 and/or Output Module 3200 may be integral to the Computing Platform 3300. Computing Platform 3300 may be located in the same location, or at a geographically separate location, from Input Module 3100 and/or Output Module 3200 by using dedicated communication links or a network.

Input Module 3100 may be implemented with a wide variety of devices to receive and/or store information. Referring to FIG. 3, Input Module 3100 may include an Input Device 3110 and/or a Storage Device 3120. Input Device 3110 may further include a keyboard, a mouse, a disk drive, a telephone, or any other suitable input device for receiving and/or providing information to Computing Platform 3300. Although FIG. 3 shows only a single Input Module 3100, a plurality of Input Modules 3100 may also be used. Storage Device 3120 may be implemented with a wide variety of systems, subsystems and/or devices for providing memory or storage including, for example, one or more of the following: a read-only memory (ROM) device, a random access memory (RAM) device, a tape or disk drive, an optical storage device, a magnetic storage device, a redundant array of independent disks (RAID), cloud storage, and/or any other device capable of providing storage and/or memory.

Network Interface 3400 may exchange data between the Communication Channel 1400 and Computing Platform 3300. In one embodiment, Network Interface 3400 may permit a connection to at least one or more of the following networks: an Ethernet network, an Internet protocol network, a telephone network, a radio network, a cellular network, a wireless local area network (LAN), or any other network capable of being connected to Input Module 3100.

Output Module 3200 may include, but is not limited to, devices capable of presenting information to a user of the Processor 1350 such as a Display 3210 and/or a Printer 3220. Output Module 3200 may be used to display and/or print, inter alia, the indication, such as a score, representative of the likelihood that a bank will default. Output also may be stored for later presentation on a storage device similar to 3120. Moreover, Output Module 3200 may be used to print or display any information received, such as financial ratios, bank structure information, or other information as described above in the discussion of FIG. 2. Although FIG. 3 only illustrates a single Output Module 3200, a plurality of Output Modules 3200 may be used.

For one or more banks, Banking Database 2100 may store Quarterly Bank Call Report Information 2110, Bank Structure Information 2120, Bank Closure Information 2130, and/or Other Information 2140. Moreover, Banking Database 2100 may store information including financial information, demographic information, credit information, and other public and/or proprietary information that is kept within an entity or organization. For example, Banking Database 2100 may store information received from Information Source(s) 1800 and transformed by Processor 1350, such as bank financial ratios, geographic information, closure information, and national and regional economic indicators. The information stored in Banking Database 2100 may be received from any server including Information Source(s) 1800 and/or entities 1500-1710, or may be received via the one or more input modules 3100. Although Banking Database 2100 is shown in FIG. 3 as being located with Computing Platform 3300, the database (or databases) may be located anywhere (or in multiple locations) and connected to Computing Platform 3300 via direct links, Network Interface 3400, or another network interface.

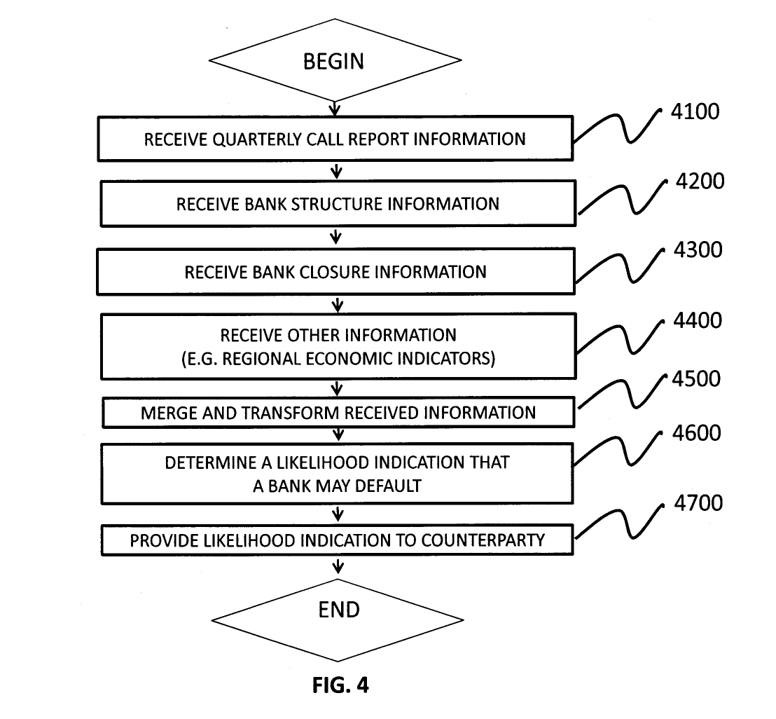

FIG. 4 is a flowchart depicting exemplary steps for providing an indication that a bank is likely to default. Referring to FIG. 3 and FIG. 4, in one embodiment, Processor 1350 may receive via Communications Channel 1400 bank information, including Quarterly Bank Call Report Information (step 4100) and Bank Structure Information (step 4200). Processor 1350 may also receive Bank Closure Information (step 4300) and Other Information (step 4400), such as current national or regional economic indicators. Based on at least one of the received quarterly call reports, received structure information, received information on bank failures, and other received information, Processor 1350 merges the received information and then transforms the received information into new variables, such as financial ratios EQTA, NPATA, ROA, BDTA, SECTA, and CDTA (step 4500) as described below. Processor 1350 then uses these new variables as inputs into PD Score Model 2200 to determine the Likelihood Indication 2300 that the bank may default (step 4600). Processor 1350 may then populate Bank Database 2100 with Likelihood Indication 2300. Processor 1350 may then provide, through Communication Channel 1400, the Likelihood Indication 2300 to counterparties, such as Financial Institutions 1500, 1510, Equity Investors 1600, 1610, or Other Counterparties 1700, 1710 (step 4700), or may cause the Likelihood Indication 2300 to be output via the one or more Output Module(s) 3200. With that general overview, the following describes in greater detail exemplary steps 4100-4600.

To receive Quarterly Bank Call Report Information (step 4100), Processor 1350 may receive from an entity, such as Information Source 1800, Quarterly Bank Call Report Information 2110 through Communication Channel 1400.

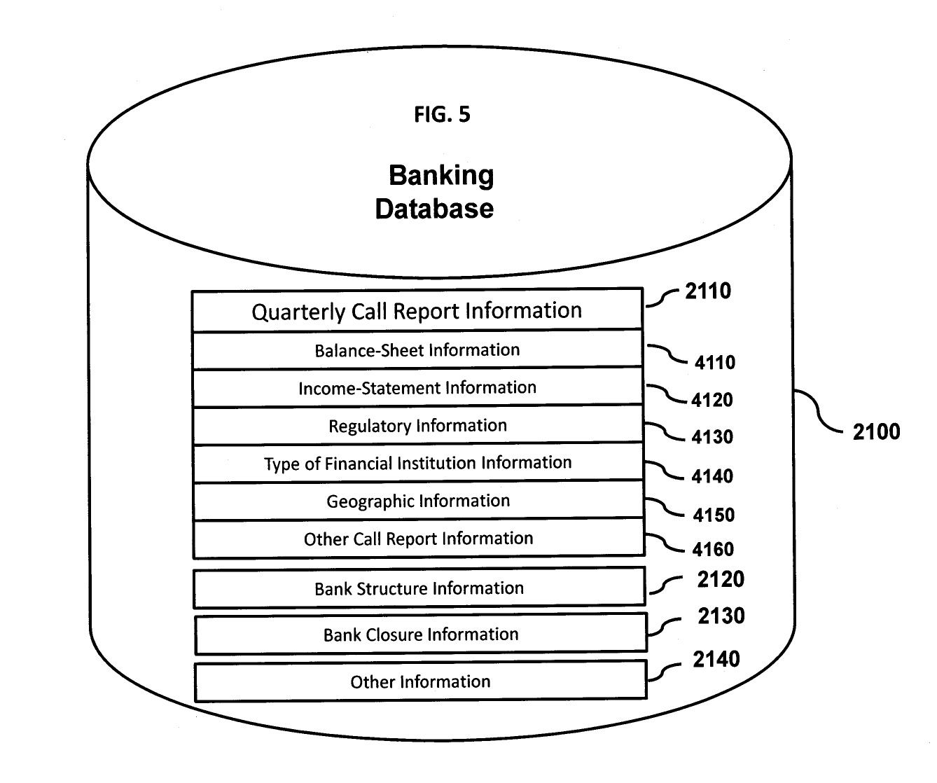

FIG. 5 depicts Banking Database(s) 2100 with an example of Quarterly Bank Call Report Information 2110. Referring to FIG. 5, Quarterly Bank Call Report Information 2110 includes Balance-Sheet Information 4110, Income-Statement Information 4120, Regulatory Information 4130, Type of Financial Institution Information 4140, Geographic Information 4150, and Other Call Report Information 4160.

Balance-Sheet Information 4110 includes one or more of the following for specific financial institutions such as individual banks: Total Assets, Total Equity, Past Due Loans, Nonaccrual Loans, Foreclosed Real Estate, Brokered Deposits, Construction & Development Loans, and Total Investment Securities; but also may include additional balance-sheet items.

Income Statement Information 4120 includes one or more of the following for specific financial institutions such as individual banks: Net Income, Net Interest Income, and Provisions for Loan Losses; but also may include additional income-statement items.

Regulatory Information 4130 generally describes the regulatory environment surrounding a specific financial institution or bank including the bank's primary regulator: the Office of the Comptroller of the Currency (OCC), FDIC, Federal Reserve, or Office of Thrift Supervision (OTS); but also may include additional regulatory information.

Type of Financial Institution Information 4140 describes the type of financial institution, including one or more of the following: commercial bank, credit union, investment bank, mortgage bank, savings bank, or savings association; but also may include additional types.

Geographical Information 4150 includes information on the geographical location of the financial institution, including city, county, Metropolitan Statistical Area (MSA) and state; but also may include additional information on geographic location.

Other Call Report Information 4160 includes any other information not enumerated above, but appearing as part of the Bank Call Report Information.

Also shown in FIG. 5 are Bank Structure Information 2120, Bank Closure Information 2130 and Other Information 2140.

Bank Structure Information 2120 may include one or more of the following: bank name, unique Federal Reserve entity identification number, unique FDIC certificate number, unique OTS docket number, holding company affiliation, regulatory high-holder information, number of branches, and legal form of organization (S-corporation, C-Corporation or Mutual); but also may include additional structure information.

Bank Closure Information 2130 includes information identifying each bank closed by its primary regulator, including bank name, location (city and state), FDIC certificate number, Federal Reserve entity identification number, and any other information provided about the closed bank.

Other Information 2140 includes any other information that may be useful in generating the indication of the probability of default, such as information on regional and economic conditions. This includes, but is not necessarily limited to, information from the Bureau of Labor Statistics, the Bureau of Economic Analysis, Bloomberg, Case-Shiller, Core Logic, Lender Processing Services, etc. Other Information 2140 includes measures of national and regional economic conditions, such as state and national unemployment rates, GDP growth, loan default rates, mortgage foreclosure rates, housing prices, income per capita and other measures of national and regional economic conditions.

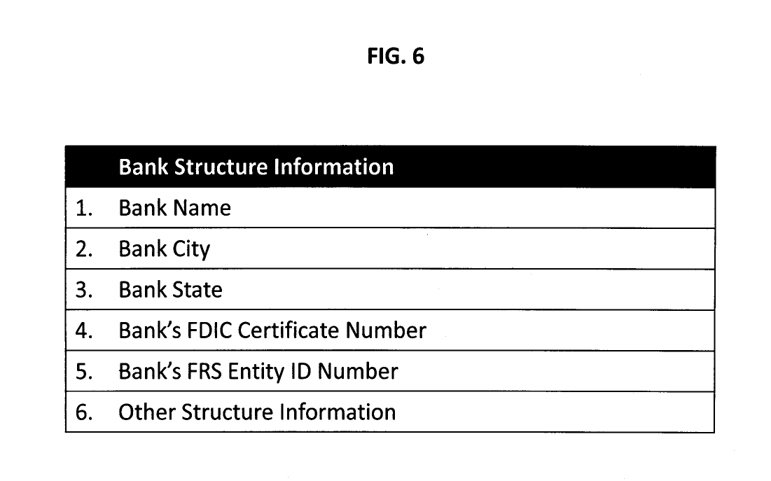

FIG. 6 depicts an example of Bank Structure Information 2120. Referring to FIG. 6, the Bank Structure Information 2120 may include the name of the bank, the name of the city and state in which the bank is headquartered, the unique FDIC Certificate number, the unique Federal Reserve Entity ID number, and Other Structure Information. An example of Bank Closure Information 2130 would look virtually identical to FIG. 6, except that it would only be provided for banks that were closed by their primary regulator.

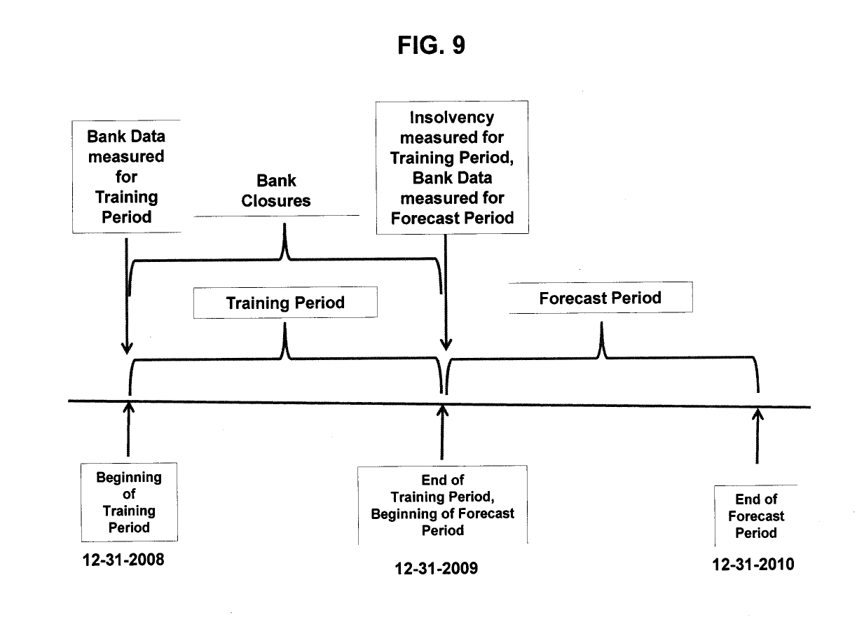

To determine a Likelihood Indication 2300 that a bank may default (step 4600), Processor 1350 may process Transformed Information 2150 received from Banking Database 2100. In one embodiment, Processor 1350 determines the Likelihood Indication 2300 in the form of a score. The score (also referred to herein as a Probability of Default or “PD”) provides an indication of whether the bank defaulted during the training period, which is described in discussion of FIG. 9. In an early warning component of the system, Processor 1350 also determines a predicted Likelihood Indication 2300 that further indicates whether a bank will default on or before a specified date in the future, i.e., during a forward-looking “forecast” period, (described in discussion of FIG. 9) such as a default within one calendar year. However, as one skilled in the art would know, the “forecast” period could be two years, five years or any desirable period of time.

In one embodiment, the PD is scaled into a range of 0.000 to 1.000, such that a PD of greater than 0.500 indicates a very high probability that a bank will default within the forecast period. A PD between 0.100 and 0.500 indicates a medium-to-high probability that a bank will default within the forecast period. A PD between 0.010 and 0.10 indicates a low probability that a bank will default within the forecast period, and a PD less than 0.010 indicates an extremely low probability that a bank will default within the forecast period. Alternatively, the PD may be scaled into a range of 1 to 20, corresponding to the standard corporate bond ratings used by many bank counterparties. In this case, a higher score indicates a higher probability of default. Once again, any desirable ranking or order scale or scheme could be employed for indicating the relative likelihood that a bank will default.

In one aspect, the PD is determined based on a model as well as the Transformed Information 2150 from Bank Database 2100. The information received in steps 4100-4400 as of the beginning of the training time period (and then transformed in step 4500) are used to initialize (or set) the values of variables in the model, such as the PD Score model 2200. For example, if the training period is one calendar year beginning Jan. 1, 2009, and ending Dec. 31, 2009, then the information received in steps 4100-4400 would be taken from Dec. 31, 2008. However, a skilled artisan will recognize that this information also could be taken from a period one, two, four, or more quarters prior to the beginning of the training period.

Table 1 below lists exemplary variables that may be used in the PD Score Model 2200. However, a skilled artisan will recognize, based on reading the detailed description herein, that any number of variables may be used to determine a likelihood indication, such as the PD.

TABLE 1

| VARIABLE | EXPLANATION |
|---|---|
| EQTA | ratio of total equity to total assets |
| NPATA | ratio of nonperforming assets to total assets |
| ROA | ratio of net income to total assets |
| BDTA | ratio of brokered deposits assets to total assets |
| SECTA | ratio of investment securities to total assets |
| CDTA | ratio of construction & development loans to |
| | total assets |

The variable “EQTA” represents the ratio of total equity to total assets for each bank. For example, a bank with $100 million in total equity and $1.000 billion in total assets would have a value of 0.100 for EQTA. A bank with high capitalization may have a high ratio EQTA, e.g. 0.200; while a bank with low capitalization may have a low ratio EQTA, e.g., 0.020.

The variable “NPATA” represents the ratio of nonperforming assets to total assets for each bank. For example, a bank with $50 million in nonperforming assets and $1.000 billion in total assets would have a value of 0.050 for NPATA. A bank with good asset quality may have a low ratio NPATA, e.g., 0.010; while a bank with poor asset quality may have a high ratio of NPATA, e.g., 0.180.

The variable “ROA” represents the ratio of net income to total assets for each bank. For example, a bank with $10 million in net income and $1.000 billion in total assets would have a value of 0.010 for ROA. A bank with good earnings may have a high ratio ROA, e.g., 0.025; while a bank with poor or negative earnings may have a low ratio of ROA, e.g., −0.005.

The variable “BDTA” represents the ratio of brokered deposits to total assets for each bank, which is a measure of funding risk. For example, a bank that relies heavily upon brokered deposits for funding, with $250 million in brokered deposits and $1.000 billion in total assets, would have a value of 0.250 for BDTA. A bank that does not rely upon brokered deposits for funding may have a low value of BDTA, e.g., 0.005.

The variable “SECTA” represents the ratio of investment securities to total assets for each bank, which is a measure of liquidity. For example, a bank with $150 million in investment securities and $1.000 billion in total assets would have a value of 0.150 for SECTA. A bank with good liquidity may have a high ratio SECTA, e.g., 0.300; while a bank with poor liquidity may have a low ratio of SECTA, e.g., 0.100.

The variable “CDTA” represents the ratio of construction & development loans to total assets for each bank, which is viewed by regulators as an extremely risky type of loan. For example, a bank with $100 million in such loans and $1.000 billion in total assets would have a value of 0.100 for CDTA. A bank with high risk may have a high ratio CDTA, e.g., 0.300; while a bank with low risk may have a low ratio of CDTA, e.g., 0.030.

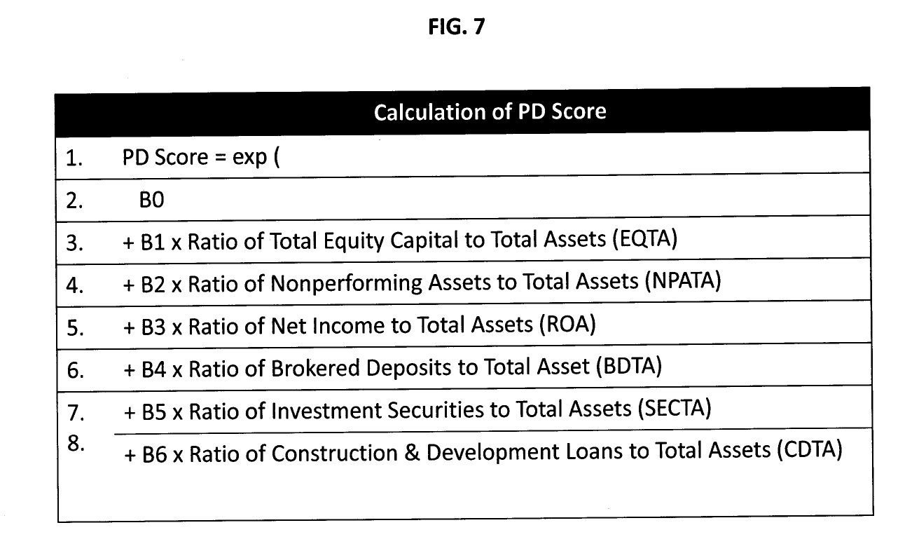

FIG. 7 depicts an exemplary calculation of a PD using PD Score Model 2200. Based on the exemplary PD Score Model 2200 depicted in FIG. 2, Processor 1350 (or Computing Platform 3300 therein) may determine a PD by first determining the product(s) of the model coefficient(s) and the corresponding variable(s) (lines 3-8). For example, Computing Platform 3300 may determine the product of the value of model coefficient “B1” and the value of the variable EQTA (described above) by multiplying these two values (line 3). Once these products are calculated (lines 3-8), they are summed along with the estimated intercept coefficient B0 (line 2).

As illustrated in line 1 of FIG. 7, the Processor 1350 exponentiates this sum in order to produce a PD. One skilled in the art may add, modify, or use any combination of these variables to produce a PD and/or PD Score Model. With the PD determined, Processor 1350 may populate Banking Database 2100 with these values. Processor 1350 also may provide the determined PD to a counterparty, such as Financial Institutions 1500, 1510, Equity Investors 1600, 1610, and Other Counterparties 1700, 1710 through network interface 3400 and Communication Channel 1400 (step 4700). The PD Score may be provided through a network interface, such as a web browser.

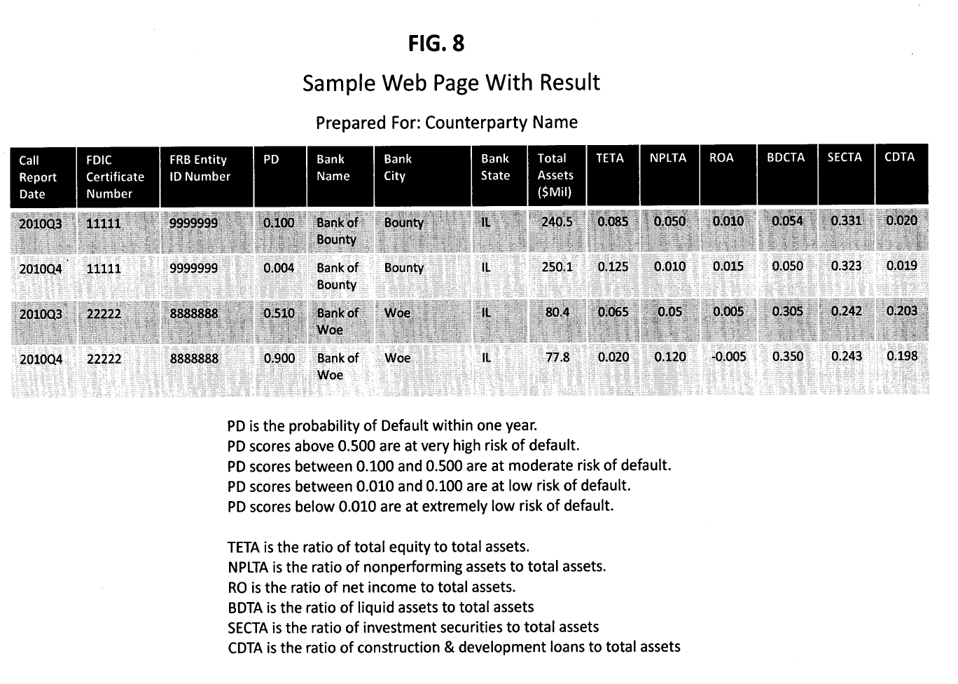

FIG. 8 depicts an exemplary web page showing how a bank's PD might be distributed to one or more counterparties, such as Financial Institutions 1500, 1510 Equity Investors 1600, 1610, or Other Counterparties 1700, 1710. As illustrated in FIG. 8, the PD may provide one or more counterparties with an indication of whether the bank may default during the forecast period. For example, FIG. 8 depicts that a PD Score above 0.500 may be considered at “very high risk of default.” When that is the case, Financial Institutions 1500, 1510, Equity Investors 1600, 1610, or Other Counterparties 1700, 1710 may allocate their resources accordingly, e.g., the counterparty may take actions to reduce its risk exposure to the bank in question. When the PD is between 0.100 and 0.500, the bank is considered to be at “moderate risk of default.” When a PD is between 0.010 and 0.100, the likelihood that a bank may default is considered to be at “low risk of default.” A bank with a PD below 0.010 is considered to be at “extremely low risk of default.”

In some instances, Processor 1350 may determine the PD repeatedly over time until the bank defaults (step 4600). In one embodiment, Processor 1350 may repeat steps 4200-4500 on a weekly, monthly, quarterly, or annual basis until the bank defaults. In another case, Processor 1350 may perform an initial PD determination, and then determine another PD on a weekly, monthly, quarterly, or annual basis until the bank defaults. Those having ordinary skill in the art will appreciate that any suitable time period for repeating the PD determination may be employed as a matter of design choice.

As shown in FIG. 8, the presentation of PDs from successive time periods enables counterparties to determine if the bank's likelihood of default is rising or falling. The PD of Bank of Bounty decreases from 0.100 in 2010Q3 to 0.004 in 2010Q4, making it attractive to an investor looking to take a long equity position or to a depositor looking for a safe bank; whereas the PD of Bank of Woe increases from 0.510 in 2010Q3 to 0.900 in 2010Q4, making it an attractive to an investor looking to take a short equity position but unattractive to a depositor looking for a safe bank.

FIG. 9 is an exemplary timeline that shows how the Transformed Information 2150 from the Banking Database 2100 feeds into the statistical model. There are two periods involved in the process—a “Training Period,” where the model coefficients are estimated, and a “Forecast Period,” where the model coefficients B0, B1, . . . , BN estimated using data from the Training Period are used in conjunction with Transformed Information 2150 for the Forecast Period to generate the forward-looking PD score.

To estimate the model coefficients, Transformed Information 2150 from Bank Database 2100 are measured as of the beginning of the Training Period, which is shown as 12-31-2008. A skilled artisan will recognize that Transformed Information 2150 also could be measured one month, one quarter, two quarters, one year, or earlier than the beginning of the Training Period. Bank closures observed during calendar year 2009 are used in creation of the dependent variable DEFAULT, where failing banks are assigned a value of one and banks surviving until the end of 2009 are assigned a value of zero. A skilled artisan will recognize that the training period could be shorter than one year, e.g. six months or even three months; or longer than one year, e.g., two years or even five years. At the end of the training period, shown as 12-31-2009, insolvent banks are classified as those reporting nonperforming assets equal to at least twice their equity capital. A skilled artisan will recognize that insolvent banks could be classified based upon alternative criteria, such as nonperforming assets equal to their equity capital. These banks also are assigned a value of one for the dependent variable DEFAULT. Next, the PD Score Model 2200 is estimated to generate values of model coefficients B0, B1, . . . BN. To create the forward-looking PD Score, Transformed Information 2150 from Banking Database 2100 are measured as of the end of the training period, which is also the beginning of the forecast period, shown as 12-31-2009. Coefficients B0, B1, . . . , BN estimated using Transformed Information 2150 from the beginning of Training Period (12-31-2008) are applied to the Transformed Information 2150 from the beginning of the forecast period (12-31-2009) to generate the forward-looking PD Score for the Forecast Period (shown as calendar year 2009).

In one embodiment, Processor 1350 (or Computing Platform 3300 therein) may also generate the PD Score Model 2200. Although the PD Score Model 2200 is described, any type of model or mathematical transform may be used instead.

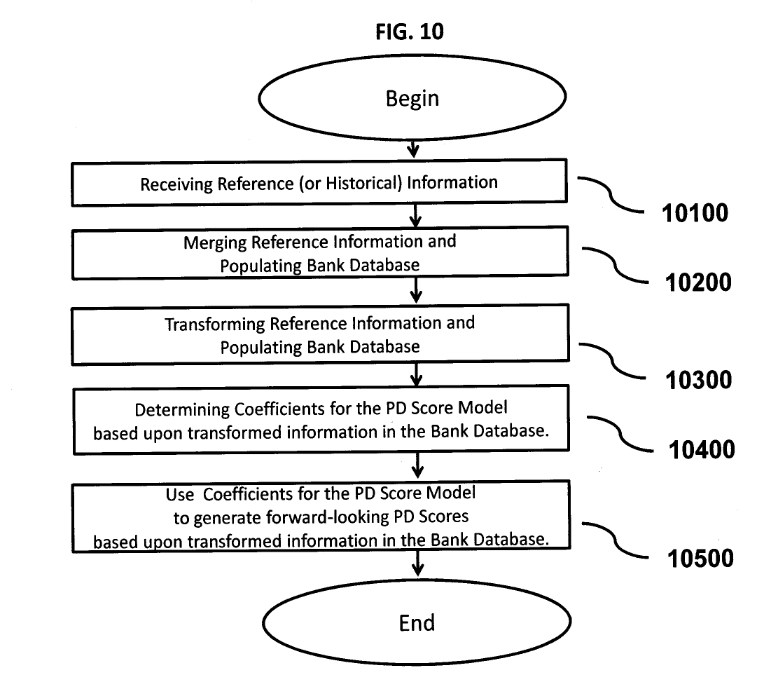

FIG. 10 shows a flowchart depicting the steps associated with generating the forward-looking PD. Computing Platform 3300 may receive Reference (also referred to by those of ordinary skill as “historical” or “truth”) Information (step 10100); Processor 1350 merges Reference Information and populates Bank Database 2100 with this information (step 10200); Processor 1350 transforms Reference Information into financial ratios and other variables useful for modeling default (Transformed Information 2150), and populates Bank Database 2100 with this Transformed Information 2150 (step 10300); Processor 1350 determines coefficients (or weights) B0, B1, . . . , BN for the PD Score Model 2200 based on the Transformed Information 2150 for the Training Period (step 10400); and then Processor 1350 uses these estimated coefficients in conjunction with Transformed Information 2150 for the Forecast Period to generate the forward-looking PD Scores (step 10500).

Computing Platform 3300 may receive from Information Source(s) 1800 through Communications Channel 1400 or from Banking Database 2100 Reference Information from one or more banks (step 10100). The Reference Information may include Quarterly Call Report Information 2110, Bank Structure Information 2120, Bank Closure Information 2130, and/or any Other Information 2140, such as indicators of national or regional economic conditions. Bank Closure Information 2130 identifies whether each of the reference banks defaulted within a given time span. The Reference Information may include information that is considered reliable and, preferably, verified (e.g., “truth” data).

To determine the Coefficients of the PD Score model (step 10200), Computing Platform 3300 may process the Transformed Information 2150 from Banking Database 2100 based on statistical techniques, such as a logistic regression as known in the art. By using statistical techniques, Computing Platform 3300 may determine the corresponding Coefficients (or weights) of the PD Score Model 2200, such that the model can generate a PD Score. Referring again to FIG. 7, the exemplary PD Score Model 2200 estimates values for coefficients including the following: B0, B1, B2, B3, B4, B5 and B6. In practice, the model may contain additional variables to the six shown in FIG. 7. Computing Platform 3300 thus uses a statistical technique to determine the value of each of these coefficients.

In one embodiment, Computing Platform 3300 may use a statistical technique referred to as logistic regression to determine the coefficients in step 10400. Logistic regression models may be used to examine how various factors influence a binary outcome, such as default or no default. An event (or result) that has two possible outcomes is a binary outcome (e.g., good/bad or default/not default). Logistic modeling is available with many statistical software packages. For example, the commercially available statistical packages offered by SAS Institute Inc. and StataCorp LP include logistic regression modeling tools.

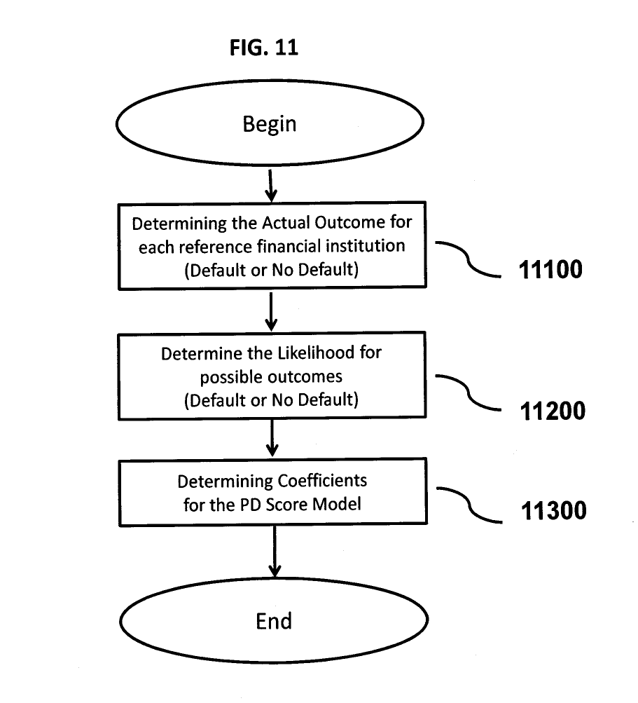

FIG. 11 shows an exemplary flowchart with steps for determining coefficients of a model, such as the PD Score Model 2200 based on a logistic regression approach. The logistic regression approach permits determining coefficients for the PD Score model based on the reference information received in step 10100 and transformed into explanatory variables in step 10300. Referring to FIG. 11, Computing Platform 3300 may determine the Actual Outcome (e.g., whether the reference bank defaults or does not default within the specified training period span) for each bank included in the Reference Information (step 11100); determine the Likelihood (or probability) associated with each of those outcomes (step 11200); and determine Coefficients (or weights) for the PD Score model (step 11300). With that general overview, steps 11100-11300 will be described below in greater detail.

To determine the outcome for each of the reference banks included in the Reference Information (step 11100), Computing Platform 3300 may determine whether the bank defaulted or not during the Training Period/Forecast Period, which may be one calendar year. When a bank defaults within Training Period/Forecast Period, Computing Platform 3300 may set the outcome variable DEFAULT to a value of “1.” When a bank does not default within the Training Period/Forecast Period, Computing Platform 3300 may set the outcome variable DEFAULT to a value of “0.” Alternatively, the outcome variable DEFAULT may be defined as whether the bank defaults within a Training Period/Forecast Period of a length different than one year, such as within two, three, four, five or ten calendar years.

The variable DEFAULT is based upon three mutually exclusive outcomes. The first outcome is where the bank is closed by its primary regulator during the Training Period; the second outcome is where the bank is not closed but, at the end of the Training Period, reports that the value of its noncurrent loans are more than twice the value of its equity capital; the third outcome is where the bank is not closed and, at the end of the Training Period, reports that the value of its noncurrent loans is less than twice the value of its equity capital. If outcome one or two is observed, then the variable DEFAULT is assigned a value of “1”; if outcome three is observed, then the variable DEFAULT is assigned a value of “0”. For example, if the Training Period is one calendar year beginning Jan. 1, 2010, and ending Dec. 31, 2010, then outcome one would be based upon bank closures observed between Jan. 1, 2010 and Dec. 31, 2010; outcome two would be based upon the bank's equity and noncurrent loans reported on its financial reports as of Dec. 31, 2010; and outcome three would be based upon not observing outcomes one or two. These outcomes would be matched explanatory variables constructed using Reference Information from Dec. 31, 2009.

Referring again to FIG. 11, Computing Platform 3300 may determine the Likelihood Indication 2300 for each of the two possible outcomes DEFAULT or NO DEFAULT (step 11200). To determine the Likelihood Indication 2300, Computing Platform 3300 may further process the Transformed Information 2150 from Bank Database 2100, using a logistic regression, to determine the Likelihood Indication 2300. For example, the Computing Platform 3300 may determine the Likelihood Indication 2300 that a bank defaults (or, alternatively, does not default) within the Forecast Period based on the following variables (or factors): EQTA, NPATA, ROA, BDTA, SECTA, and CDTA.

In one embodiment, Computing Platform 3300 uses the following equation to determine the odds, or likelihood that a bank will default within the Training Period:

Log(PD/(1−PD))=B0+B1*EQTA+B2*NPATA+B3*ROA+B4*BDTA+B5*SECTA+B6*CDTA (Eq. 1)

wherein PD is the likelihood of default for a particular bank during the Training Period; Log(PD/(1−PD) is the log odds (also referred to as LOGIT) that the bank will default within the Training period; EQTA, NPATA, ROA, BDTA, SECTA and CDTA are financial ratio defined above; and B0, B1, B2, B3, B4, B5 and B6 are estimated model coefficients. Before Computing Platform 3300 utilizes a logistic regression, the values of “B0,” “B1,” “B2,” “B3,” “B4,” “B5” and “B6” and “PD” may be unknown.

In this example, the Computing Platform 3300 estimates seven coefficients (i.e., n=7) corresponding to an intercept and the six explanatory variables: EQTA, NPATA, ROA, BDA, SECTA and CDTA. Although this example uses seven coefficients, a skilled artisan would recognize that additional coefficients and corresponding variables may be used instead. Indeed, any other variables (or factors) may be used that serve as an indication of whether a bank is likely to default, and the selection of these six is only exemplary to facilitate explanation herein.

Although PD is an unknown value at the start of the logistic regression, PD may conform to the following equation:

PD=1/(1+e^{tau}) (Eq. 2)

where tau is the following:

tau=B0+B1*EQTA+B2*NPATA+B3*ROA+B4*BDTA+B5*SECTA+B6*CDTA (Eq. 3)

Computing Platform 3300 may then determine an estimate of the coefficients of the PD Score model (step 11300). That is, the Computing Platform 3300 may solve for estimated values for B0, B1, B2, B3, B4, B5, and B6 using equations 1-3.

Although Computing Platform 3300 may utilize a logistic regression approach as described in this example, a skilled artisan would recognize that alternative approaches may be used instead to determine the coefficients, such as probit regression, standard ordinary-least-squares (“OLS”) regression, a linear probability model, a survival (or hazard) model, a neural network, a classification tree, or any other statistical or quantitative approach that may provide coefficients based on reference information (or truth data).

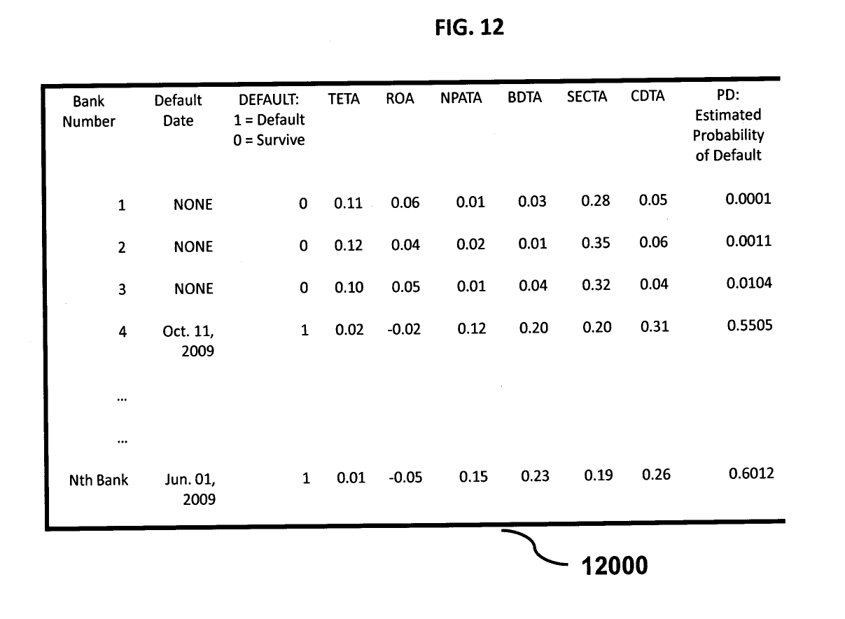

FIG. 12 depicts an exemplary table 12000, showing Transformed Information 2150 associated with generating PD Scores (Likelihood Indication 2300) using the PD Score Model 2200. Referring to FIG. 12, the Transformed Information 2150 covers “N” reference banks, of which Bank Numbers “4” and “N” default during calendar year 2009 (as indicated by the Default Date), while Bank Numbers “1,” “2” and “3” did not default during calendar year 2009 (as indicated by “NONE”). Computing Platform 3300 thus processes Transformed Information 2150 on each bank to determine the value of the Likelihood Indication 2300, storing the information depicted in FIG. 12 in Banking Database 2100.

The System 1000 may be embodied in various forms, including, for example, a data processor, such as the computer that also includes a database. Moreover, the above-noted features and other aspects and principles of the instant disclosure may be implemented in various environments. Such environments and related applications may be specially constructed for performing the various processes and operations of the instant disclosure, or they may include a general-purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with the instant teachings, or it may be more convenient to construct a specialized apparatus or system to perform the required methods and techniques.

Apparatus, systems and methods consistent with the instant disclosure also include computer-readable media (or memory) that include program instructions or code for performing various processing device-implemented operations based on the methods and processes described herein. The media and program instructions may be those specially designed and constructed for the purposes of the instant disclosure, or they may be of the kind well known and available to those having skill in the computer software arts. Examples of program instructions include, for example, machine code, such as produced by a compiler, and files containing a high-level code that can be executed by the computer using an interpreter.

Furthermore, although the embodiments above refer to processing information related to banks, systems and methods consistent with the instant disclosure may process information related to other types of financial institutions, including credit unions, mortgage banks, savings associations and savings banks. Moreover, although reference is made herein to using the PD Score to assess a bank, in its broadest sense systems and methods consistent with the instant disclosure may provide a score for any type of company, including nonfinancial firms.

While particular preferred embodiments have been shown and described, it is to be understood that the foregoing description is exemplary and explanatory only and is not restrictive of the instant disclosure. Those skilled in the art will appreciate that changes and additions may be made without departing from the instant teachings. For example, the teachings of the instant disclosure may be directed to various combinations and sub-combinations of the disclosed features and/or combinations and sub-combinations of several further features described herein. It is therefore contemplated that any and all modifications, variations or equivalents of the above-described teachings fall within the scope of the basic underlying principles disclosed above and claimed herein.

What is claimed is:

1. A method for determining a probability of default for at least one depository institution, the method comprising:
populating, by at least one processing device, a banking database with information regarding financial condition and performance of individual depository institutions to provide reference information;
transforming, by the at least one processing device, the reference information into variables that can be used to model the probability of default;
calculating, by the at least one processing device, a probability of default based on a probability of default model and the variables for each depository institution for which information is available in the banking database; and
transmitting, by the at least one processing device, the probability of default for each depository institution to at least one depository institution counterparty.

2. The method of claim 1, wherein the banking database is populated by the at least one processing device through a communication channel operatively connected to various data sources.

3. The method of claim 1, wherein calculating the probability of default further comprises determining the probability of default model based on logistic regression analysis of at least a portion of the reference information.

4. The method of claim 3, in which the logistic regression formula is:
Log(PD/(1−PD))=B0+B1*EQTA+B2*NPATA+B3*ROA+B4*BDTA+B5*SECTA+B6*CDTA
Wherein:
PD is a the default probability for a particular depository institution,
EQTA is a variable expressing a ratio of total equity capital to total assets for the depository institution,
NPATA is a variable expressing a ratio of non-performing assets to total assets for the depository institution,
ROA is a variable expressing a ratio of net income to total assets for the depository institution,
BD is a variable expressing a ratio of brokered deposits to total assets for the depository institution,
SECTA is a variable expressing a ratio of investment securities to total assets for the depository institution,
CDTA is a variable expressing a ratio of construction and development loans to total assets for the depository institution,
and B0, B1, B2, B3, B4, B5 and B6 are coefficients estimated by the model.

5. The method of claim 4, wherein the values of EQTA, NPATA, ROA, BD, SEC and CDTA are based on reference information in the banking database.

6. The method of claim 1, wherein calculating the probability of default further comprises placing the probability of default into a plurality of ranges, such that a low range within the plurality of ranges corresponds to a low likelihood that the depository institution will default, and a high range within the plurality of ranges corresponds to a high likelihood that the depository institution will default.

7. An apparatus for determining a probability of default for at least one depository institution, the apparatus comprising:
a processing device; and
memory, operatively connected to the processing device, having stored thereon instructions that, when executed by the processing device, cause the processing device to:
populate a banking database with information regarding financial condition and performance of individual depository institutions to provide reference information;
transform the reference information into variables that can be used to model the probability of default;
calculate a probability of default based on a probability of default model and the variables for each depository institution for which information is available in the banking database; and
transmit the probability of default for each depository institution to at least one depository institution counterparty.

8. The apparatus of claim 7, wherein the processing device is operatively connected to a communication channel, and wherein those instructions that cause the processing device to populate the banking database are further operative to cause the processing device to populate the banking database with data taken from various data sources operatively connected to the communication channel.

9. The apparatus of claim 8, wherein those instructions that cause the processing device to calculate the probability of default are further operative to cause the processing device to determine the probability of default model based on logistic regression analysis of at least a portion of the reference information.

10. The apparatus of claim 9, in which the logistic regression formula is:
Log(PD/(1−PD))=B0+B1*EQTA+B2*NPATA+B3*ROA+B4*BDTA+B5*SECTA+B6*CDTA
Wherein:
PD is a the default probability for a particular depository institution,
EQTA is a variable expressing a ratio of total equity capital to total assets for the depository institution,
NPATA is a variable expressing a ratio of non-performing assets to total assets for the depository institution,
ROA is a variable expressing a ratio of net income to total assets for the depository institution,
BD is a variable expressing a ratio of brokered deposits to total assets for the depository institution,
SECTA is a variable expressing a ratio of investment securities to total assets for the depository institution,
CDTA is a variable expressing a ratio of construction and development loans to total assets for the depository institution,
and B0, B1, B2, B3, B4, B5 and B6 are coefficients estimated by the model.

11. A computer-readable medium having store thereon instructions that, when executed by a processing device, cause the processing device to:
populate a banking database with information regarding financial condition and performance of individual depository institutions to provide reference information;
transform the reference information into variables that can be used to model the probability of default;
calculate a probability of default based on a probability of default model and the variables for each depository institution for which information is available in the banking database; and
transmit the probability of default for each depository institution to at least one depository institution counterparty.

12. The computer-readable medium of claim 11, wherein the processing device is operatively connected to a communication channel, and wherein those instructions that cause the processing device to populate the banking database are further operative to cause the processing device to populate the banking database with data taken from various data sources operatively connected to the communication channel.

13. The computer-readable medium of claim 12, wherein those instructions that cause the processing device to calculate the probability of default are further operative to cause the processing device to determine the probability of default model based on logistic regression analysis of at least a portion of the reference information.

14. The computer-readable medium of claim 13, in which the logistic regression formula is:
Log(PD/(1−PD))=B0+B1*EQTA+B2*NPATA+B3*ROA+B4*BDTA+B5*SECTA+B6*CDTA
Wherein:
PD is a the default probability for a particular depository institution,
EQTA is a variable expressing a ratio of total equity capital to total assets for the depository institution,
NPATA is a variable expressing a ratio of non-performing assets to total assets for the depository institution,
ROA is a variable expressing a ratio of net income to total assets for the depository institution,
BD is a variable expressing a ratio of brokered deposits to total assets for the depository institution,
SECTA is a variable expressing a ratio of investment securities to total assets for the depository institution,
CDTA is a variable expressing a ratio of construction and development loans to total assets for the depository institution,
and B0, B1, B2, B3, B4, B5 and B6 are coefficients estimated by the model.
